(19) United States
(12) Patent Application Publication
(10) Pub. No.: US 2020/0402125 A1
(43) Pub. Date: Dec. 24, 2020

(54) GUIDE WORD RECOMMENDATION

(71) Applicant: Beijing Sankuai Online Technology Co., Ltd, Beijing (CN)

(72) Inventor: Maodi HU, Beiling (CN)

(21) Appl. No.: 16/768,058

(22) PCT Filed: Dec. 7, 2018
(86) PCT No.: PCT/CN2018/119803

§ 371 Date: May 28, 2020

(30) Foreign Application Priority Data
Mar. 14, 2018 (CN) 201810208533.7

(51) Int. Cl. G06Q 30/06; G06F 40/20; G06F 16/9535; G06N 5/04; G06N 20/00

(52) U.S. Cl. CPC G06Q 30/0613; G06F 40/20; G06N 20/00; G06N 5/04; G06F 16/9535

(57) ABSTRACT

Various embodiments provide a guide word recommendation method, a guide word recommendation device and electronic equipment. In one example, the method includes: determining a first keyword set on the basis of current interaction behavior data of a user; generating a guide word candidate set on the basis of the first keyword set, a second keyword set and a third keyword set; calculating an expected value of each piece of guide word in the guide word candidate set by using an expected value function; and determining at least one piece of the guide word with the expected value higher than a preset value threshold as a guide word to be recommended.

### CROSS-REFERENCE TO RELATED APPLICATIONS

The present application claims priority to Chinese Patent Application No. 201810208533.7, entitled “Guide Word Recommendation Method, Guide Word Recommendation Device and Electronic Equipment”, filed on Mar. 14, 2018, which is incorporated herein by reference in its entirety.

### TECHNICAL FIELD

The present disclosure relates to guide word recommendation.

### BACKGROUND

In some e-commerce platforms, such as a conversational food ordering platform, in order to guide a user to consume, a guide word may be displayed to the user, and the guide word is configured to help the user find a merchant or a commodity he/she is looking for.

### SUMMARY

According to a first aspect of the present application, a guide word recommendation method is provided, and includes:

determining a first keyword set on the basis of current interaction behavior data of a user;

generating a guide word candidate set on the basis of the first keyword set, a second keyword set and a third keyword set, where the second keyword set is obtained on the basis of historical orders and preference data of the user, and the third keyword set is obtained on the basis of trending search words and commodity supply information of a current located geographic area of the user;

calculating an expected value of a guide word by using an expected value function for each guide word in the guide word candidate set; and

determining the guide word with the expected value higher than a preset value threshold as a guide word to be recommended.

According to a second aspect of the present application, a guide word recommendation device is provided, and includes:

a first determination module, configured to determine a first keyword set on the basis of current interaction behavior data of a user;

a first generation module, configured to generate a guide word candidate set on the basis of the first keyword set, a second keyword set and a third keyword set, where the second keyword set is obtained on the basis of historical orders and preference data of the user, and the third keyword set is obtained on the basis of trending search words and commodity supply information of a current located geographic area of the user;

a calculation module, configured to calculate an expected value of a guide word by using an expected value function for each guide word in the guide word candidate set; and

a second determination module, configured to determine the guide word with the expected value higher than a preset value threshold as a guide word to be recommended.

According to a third aspect of the present application, electronic equipment is provided, and includes a memory, a processor and a computer program stored on the memory and capable of running on the processor. When the processor executes the computer program, the guide word recommendation method described according to the above first aspect is implemented.

According to a fourth aspect of the present application, a computer readable storage medium is provided. The storage medium stores a computer program. When the computer program is executed by a processor, the guide word recommendation method described according to the above first aspect is implemented.

It can be seen from the above technical solution that in the present application, the guide word may be obtained by integrating the second keyword set obtained on the basis of the historical orders and the preference data of the user, the third keyword set obtained on the basis of the trending search words (trending search commodities and trending search merchants) and commodity supply conditions of the current located geographic area of the user, and the first keyword set obtained on the basis of the interaction behavior data of the user. The second keyword set and the third keyword set will not change in a current login process of the user, so that the second keyword set and the third keyword set do not need to be updated when the guide word candidate set for each interaction is generated. The trending search words of the geographic area, the preference data of the user and the current interaction behavior of the user are comprehensively considered by the guide word recommendation method provided by the present application, so that the recommended guide word better conforms to user expectations.

### BRIEF DESCRIPTION OF THE DRAWINGS

FIG. 1 shows a schematic flow diagram of a guide word recommendation method according to an exemplary embodiment of the present application.

FIG. 2 shows a schematic flow diagram of a guide word recommendation method according to another exemplary embodiment of the present application.

FIG. 3 shows a schematic flow diagram of a guide word recommendation method according to still another exemplary embodiment of the present application.

FIG. 4 shows a schematic flow diagram of a guide word recommendation method according to yet another exemplary embodiment of the present application.

FIG. 5 shows a block diagram of a guide word recommendation device according to an exemplary embodiment of the present application.

FIG. 6 shows a block diagram of a guide word recommendation device according to another exemplary embodiment of the present application.

FIG. 7 shows a schematic structure diagram of electronic equipment according to an exemplary embodiment of the present application.

### DETAILED DESCRIPTION OF THE EMBODIMENTS

Exemplary embodiments are described in detail herein, and the embodiments are illustratively shown in the accompanying drawings. When the following descriptions relate to the accompanying drawings, unless otherwise indicated, same numbers in different accompanying drawings represent same or similar elements. The following implementations described in the exemplary embodiments do not represent all implementations that are consistent with this application. On the contrary, the implementations are merely examples of apparatuses and methods that are described in detail in the appended claims and that are consistent with some aspects of this application.

The terms used in this application are merely for the purpose of describing specific embodiments, and are not intended to limit this application. “A”, “said” and “the” in a singular form that are used in this application and the appended claims are intended to include a plural form unless another meaning is clearly indicated in context. It should also be understood that, the term “and/or” used herein indicates and includes any or all possible combinations of one or more associated listed items.

It should be understood that although the terms such as first, second, and third may be used in this application to describe various information, such information should not be limited ilk to these terms. These terms are merely used to distinguish between information of a same type. For example, first information may also be referred to as second information without departing from the scope of this application. Similarly, second information may also be referred to as first information. Depending on the context, for example, the word “if” used herein may be explained as “while” or “when” or “in response to determining”.

A guide word displayed by an e-commerce platform may be configured by an operator. The operator may configure the guide word displayed in current interaction on the basis of a click rate or a conversion rate of the guide word. The click rate of the guide word refers to a ratio of click times to display times of the guide word. The conversion rate of the guide word refers to a product of the click rate of the guide word and a click ordering rate (referring a ratio of ordering times to click times of a certain object on the e-commerce platform through the guide word). It may be discovered that the guide word targeting to the conversion rate may have low attraction degree on users with imprecise hit requirements, and in order to attract attention and continue a conversation, the guide word targeting to the click rate is easy to become a. “title attractor” to deviate from a target of a user, and may not help the user find a wanted merchant or commodity.

Various embodiments provide a guide word recommendation method so as to improve the conversion rate in an interaction process while ensuring user experience. The guide word recommendation method may be applied to electronic equipment, such as a user terminal or a server. The server sends a generated guide word to the user terminal after executing the guide word recommendation method. The user terminal displays the received guide word on an application program. A data interaction between the user terminal and the server may be implemented by installing the application program or software on the user terminal. Interaction data may include user information and commodity information. The user information may include historical records of commodities purchased by the user on the server through the application program. The commodity information may include information of merchants capable of providing sales service on the server and details of commodities which merchants can provide for customers. It should be noted that for a computer, the merchant of the present application may be a character string set in a customized way by the merchant in the server, and the character string may represent identity identification of the merchant currently browsed by the user as distinguished from other merchants on the server.

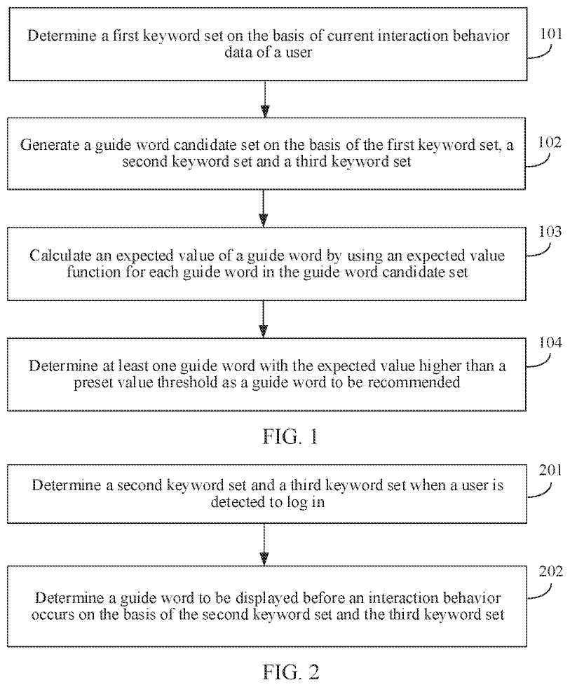

FIG. 1 shows a schematic flow diagram of a guide word recommendation method according to an exemplary embodiment of the present application. The guide word recommendation method may be applied to electronic equipment; such as a user terminal or a server. As shown in FIG. 1, the guide word recommendation method according to the present embodiment may include the following steps 101 to 103:

Step 101: A first keyword set is determined on the basis of current interaction behavior data of a user.

In an embodiment, after the user logs in an application program through the user terminal, the current interaction behavior data of the user may be determined on the basis of content input by the user, for example, keywords input in a search box; in another embodiment, after the user checks a merchant/commodity through click, the current interaction behavior data of the user may be determined on the basis of an interaction behavior.

In an embodiment, the current interaction behavior data of the user is “hamburger”, merchant data and/or commodity data such as hamburgers, chicken wings, potato strips, KFC and McDonald's may be obtained on the basis of associated commodities and/or associated merchants of the “hamburger”, and a first keyword set {hamburger, chicken wing, potato strip, KFC, McDonald's, . . . } is further generated.

On the basis of the current interaction behavior data of the user, associated merchant data and/or commodity data may be found from a first database. In an embodiment, the first database records all associated merchant data and/or commodity data, for example, if the interaction behavior data is “cheap fried rice”, merchant data and/or commodity data, for example, keywords such as Yangzhou fried rice, fried rice with eggs, omelet rice and snacks in Chengdu, associated with the “cheap fried rice” may be obtained from the first database.

In an embodiment, keywords in the first keyword set are correlated with the current interaction behavior data of the user. The correlation includes but is not limited to a conversion relationship, a same category relationship, a same taste relationship, a same food material relationship and the like among the keywords, for example, the hamburger and the chicken wing belong to the same category, and the hamburger and pungency belongs to the same taste.

Step 102: A guide word candidate set is generated on the basis of the first keyword set, a second keyword set and a third keyword set.

In an embodiment, the second keyword set is obtained on the basis of historical orders and preference data of the user, and can be generated when the user logs in the application program. Furthermore, in multi-time interactions at this time of login, the second keyword set is unchanged. The historical orders of the user show purchase records of the user through the server in a set time period, for example, the user bought the hamburgers for 10 times, pizzas for 5 times, the chicken wings and potato strips for 3 times, fried rice for 5 times and rice covered with meat and vegetables for 2 times in the recent half year, while the preference data of the user may be obtained according to historical behavior data of the user stored on the server, for example, the preference data of the user may be obtained according to all historical purchase records or the historical purchase records and historical browsing records in a set time period of the user. For example, if the user logged in the application program, and browsed pages of merchants selling the hamburgers and having a merchant identification of DEF for many times, the preference data of the user obtained on the basis of the historical purchase records and historical browsing records of the user stored on the server is fast food, hamburgers, or the like.

In an embodiment, the third keyword set is obtained on the basis of trending search words and commodity supply information of a current located geographic area of the user. In an embodiment, the server may count local trending search words, hot sales merchant categories, hot sales food categories and the like in a current time period to generate the third keyword set. For example, a western restaurant is newly opened in Miyun, and often does promotions recently, so the name of this western restaurant is a local trending search word, and when a user in a geographic position of Miyun logs in, the name of this western restaurant may be added to the third keyword set. In an embodiment, the local trending search words, the hot sales merchant categories and the hot sales food categories in the current time period will not change in the current login time period of the user, so that the third keyword set may be generated when the user logs in the application program. In an embodiment, the commodity supply information may be understood as commodity supply conditions of each merchant in the located area of the user, for example, if the supply condition of a commodity 1 of the merchant is insufficient, the commodity 1 is refused to be added to the third keyword set.

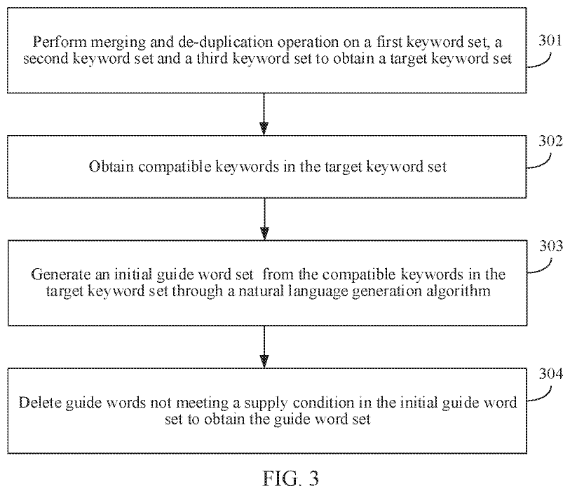

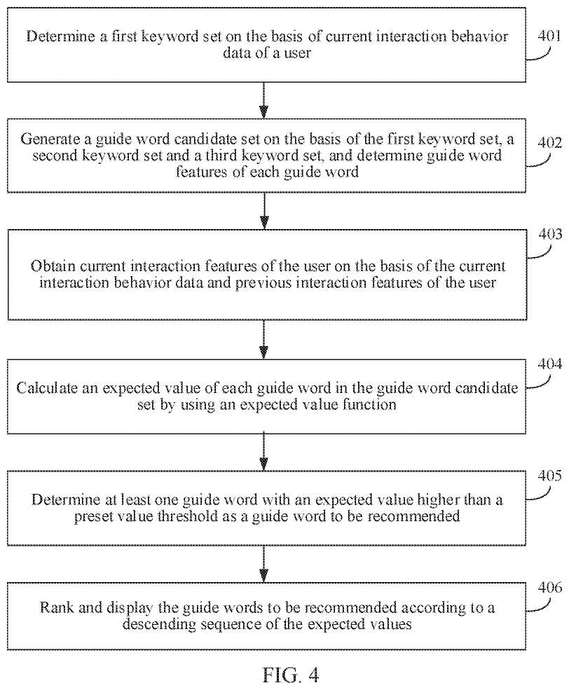

In an embodiment, for an implementation mode of generating the guide word candidate set on the basis of the first keyword set, the second keyword set and the third key word set, reference may be made to an embodiment shown in FIG. 3, and it will not be described in detail herein.

Step 103: An expected value of a guide word is calculated by using an expected value function for each guide word in the guide word candidate set.

In an embodiment, calculating the expected value of the guide word by using the expected value function for each guide word in the guide word candidate set includes obtaining current interaction features of the user, determining features of the guide word, and calculating the features of the guide word, and the current interaction features and non-interaction features of the user by using the expected value function to obtain the expected value of the guide word.

In an embodiment, the interaction feature Sₜ of the user in a t^{th} interaction may be a hidden variable output of a recurrent neural network (RNN) model in the t^{th} interaction. Furthermore, input of the RNN model is interaction behavior data of the user in the t^{th} interaction and interaction features in a (t−1)^{th} interaction. The interaction behavior data in the t^{th} interaction includes but is not limited to interaction behavior data generated by interaction behaviors such as click, ordering, active input or merchant and/or commodity detail page browsing. In the 0^{th} time, that is, when t=0, the user does not have an interaction behavior, and S₀ is a hidden variable output of a RNN initial state.

The RNN model configured to output the interaction features of the user may be a long short-term memory (LSTM) network, and the RNN model may be obtained through training on the basis of mass interaction behavior data of users.

In an embodiment, for an implementation mode of obtaining the current interaction features of the user, reference may be made to an embodiment shown in FIG. 4, and it will not be described in detail herein.

In an embodiment, features Aₜ of a guide word in the guide word candidate set include but are not limited to: keywords of the guide word, information of a commodity which the guide word is capable of being linked to, information of a merchant which the guide word is capable of being linked to, and a matching degree between the guide word and the preference data of the user. In an embodiment, the information of the commodity which the guide word is capable of being linked to includes taste, food materials, categories, a sales volume, a price and the like of the commodity, and the information of the merchant which the guide word is capable of being linked to includes a supply quantity of the commodity associated with the keywords of the guide word, a price of the supplied commodity, and the like. In an embodiment, the matching degree between the guide word and the preference data of the user includes browsing times of the keywords mentioned in the guide word by the user, purchase times, and the like. For example, if the guide word is “hamburger”, the keyword of the guide word is “hamburger”, the information of the commodity which the guide word is capable of being linked to and/or the information of the merchant which the guide word is capable of being linked to may include “KFC”, “McDonald's”, “fast food”, “beef”, “about 20 Yuan”, “great sales volume”, “supply quantity greater than 1000”, and the like, and the matching degree between the guide word and the preference data of the user is hamburger purchase times of 11 and hamburger detail page browsing times of 5 by the user. It should be noted that an interaction feature A₀ in a 0^{th} interaction is an opening guide word which is displayed in a conversation interaction window when the user logs in the application program without any input.

In an embodiment, the non-interaction features may be other factors which are irrelevant to each interaction but influence ordering of the user, and include but are not limited to: historical orders of the user, associated preference data, and other environment state features such as supply of each surrounding category, weather and solar terms. In an embodiment, the non-interaction features will not be change in a current login time period of the user, so that the non-interaction features may be determined when the user logs in the application program.

Step 104: At least one guide word with the expected value higher than a preset value threshold is determined as a guide word to be recommended.

In an embodiment, an expected value model may be trained to obtain the expected value function according to the interaction behavior data of the user generated through the application program, for example, the expected value function may be obtained according to the interaction behavior data such as historical purchase records, historical browsing records, and historical retrieval data of the user in a set time period. For example, the interaction features of the user may be extracted from the interaction behavior data of the user in each interaction, the features of the guide word are extracted for each guide word in each interaction, the expected value function is trained on the basis of a reinforcement learning method, and a training target is to enable Q(U, Sₜ, Aₜ) to approach to Rₜ₊₁+λ maxₐQ(U, Sₜ₊₁, a). A TD(0) update policy and an Adam optimization algorithm may be used, a value of α may be 0.025, and Q(U, Sₜ, Aₜ) is determined through the following formula (I):

Q(U,St,Aₜ)←Q(U,St,Aₜ)+α(Rₜ₊₁+λ max_{α}Q(U,Sₜ₊₁,α)−Q(U,St,Aₜ)) (1).

In the formula (I), α is configured to control an approaching degree of Q(U, Sₜ, Aₜ) and Rₜ₊₁+λ max_{α}Q(U, Sₜ₊₁, α), U represents the non-interaction features, Sₜ represents the interaction features in the t^{th} interaction, Aₜ represents features of a guide word in the t¹ interaction, Q(U, Sₜ, Aₜ) represents an expected value of the guide word with the features of Aₜ, Rₜ₊₁ represents an ordering number brought after the guide word with the features of Aₜ is clicked, and Rₜ₊₁>=0. If in the t^{th} interaction, the user does not click the guide word with the features of Aₜ, Q(U, Sₜ, Aₜ) is −1. λ represents a discount value. A smaller value of λ represents that the further away an ordering is from the current interaction in the subsequent interaction, the less important it is, and the value being 1 represents that the ordering in each subsequent interaction is identically important. α represents features of a guide word in a guide word set in a (t+1)^{th} interaction, that is, if it is supposed that 20 guide words exist in the guide word set in the (t+1)^{th} interaction, the expected values of the 20 guide words are first obtained, and a maximum value in the expected values of the 20 guide words is multiplied by λ. It should be noted that the TD(0) update policy refers to looking forward only for one step in a process of calculating Q(U, Sₜ, Aₜ).

In an embodiment, the expected value of the guide word may be obtained by inputting the features of the guide word and the current interaction features and the non-interaction features of the user into the expected value function.

In an embodiment, in an online application, the server may update the expected value function once after collecting new interaction behavior data of a preset number in each time, and then, the expected value of the guide word is calculated by using the new expected value function.

In an embodiment, besides determining at least one guide word with an expected value higher than a preset value threshold as a guide word to be recommended, a set number of guide words with highest expected values may also be determined as guide words to be recommended, and then, the guide words to be recommended are ranked from high to low according to the expected values and are displayed. For example, if the set number is 5, that is, 5 guide words are displayed to the user in each interaction, and 5 guide words with the highest expected values may be selected to be used as guide words to be recommended after the expected value of each the guide word in the guide word candidate set is calculated. In order to improve the conversion rate of the interaction process, the guide words may be displayed according to the descending sequence of the expected values. Compared with a displaying method of configuring the guide words on the basis of the click rate or the conversion rate of the guide words, the method of displaying the guide words according to the descending sequence of the expected values has high universality and better conforms to user expectations.

It should be noted that in the above description, only food (such as hamburger) is taken as an example for exemplary description, and commodities of the present application may further be other commodity types, such as clothes, shoes, and caps.

In the present embodiment, the guide word may be obtained by integrating the second keyword set obtained on the basis of the historical orders and the preference data of the user, the third keyword set obtained on the basis of the trending search words (trending search commodities and trending search merchants) and commodity supply conditions of the current located geographic area of the user, and the first keyword set obtained on the basis of the current interaction behavior data of the user. The second keyword set and the third keyword set will not change in the current login process of the user, so that update is not needed when the guide word for each interaction is generated. The trending search words of the geographic area, the preference data of the user and the current interaction behavior of the user are comprehensively considered by the present application, so that the recommended guide word better conforms to the user expectations. Compared with the displaying method of configuring the guide word on the basis of the click rate or the conversion rate of the guide word, the method realizes better user experience, and higher click rate and conversion rate of the guide word.

FIG. 2 shows a schematic flow diagram of a guide word recommendation method according to another exemplary embodiment of the present application. The present embodiment is on the basis of the above embodiment, and performs exemplary description by taking how to display a guide word after a user logs in software but has no interaction behavior as an example. As shown in FIG. 2, the guide word recommendation method includes the following steps 201-202.

Step 201: A second keyword set and a third keyword set are determined when the user is detected to log in.

In an embodiment, the second keyword set is obtained on the basis of historical orders and preference data of the user. The historical orders of the user shows purchase records of the user through a server in a set time period. For example, the user bought hamburgers for 10 times, pizzas for 5 times, chicken wings and potato strips for 3 times, fried rice for 5 times and rice covered with meat and vegetables for 2 times in the recent half year, while the preference data of the user may be obtained according to historical behavior data of the user stored on the server. For example, the preference data of the user may be obtained according to all historical purchase records or the historical purchase records and historical browsing records in a set time period of the user. For example, if the user logged in an application program, and browsed pages of merchants selling the hamburgers and having a merchant identification of DEF for many times, the preference data of the user obtained on the basis of the historical purchase records and historical browsing records of the user stored on the server is fast food, hamburgers, or the like.

In an embodiment, the third keyword set is obtained on the basis of trending search words and commodity supply information of a current located geographic area of the user. In an embodiment, the server may count local trending search words, hot sales merchant categories, hot sales food categories and the like in a current time period to generate the third keyword set. For example, a western restaurant is newly opened in Miyun, and often does promotions recently, so the name of this western restaurant is a local trending search word, and when a user in a geographic position of Miyun logs in, the name of this western restaurant may be added to the third keyword set. In an embodiment, the local trending search words, the hot sales merchant categories and the hot sales food categories in the current time period will not change in the current login time period of the user, so that the third keyword set may be generated when the user logs in the application program. In an embodiment, the commodity supply information may be understood as commodity supply conditions of each merchant in the located area of the user, for example, if the supply condition of a commodity 1 of the merchant is insufficient, the commodity 1 is refused to be added to the third keyword set.

Step 202: A guide word to be recommended is determined before an interaction behavior occurs on the basis of the second keyword set and the third keyword set.

In an embodiment, merging and de-duplication operation may be performed on the second keyword set and the third keyword set to obtain a fourth keyword set. Then, keywords in the fourth keyword set are subjected to compatibility judgment to obtain compatible keywords. Incompatible keywords are removed. For example, pungency+hamburger are compatible, and pungency+coffee are incompatible. An implementation mode of the compatibility judgment includes but is not limited to commodity label statistics and artificial voting.

In an embodiment, the guide words are generated from the compatible keywords in the fourth keyword set through a natural language generation algorithm so as to obtain a guide word candidate set before the interaction behavior occurs. Then, the guide word best matched with the historical orders of the user in the guide word candidate set before the interaction behavior occurs may be determined as the guide word to be recommended, so that the guide word best conforming to user preference may be displayed. The guide word best matched with the historical orders of the user in the guide word candidate set before the interaction behavior occurs may be determined as a first guide word to be recommended, and then, a small number of guide words best matched with current trending search words are selected to be used as second guide words to be recommended, so that recent trending search commodities and/or merchant information may be displayed to the user while the guide words best conforming to the user preference are displayed.

In an embodiment, an implementation mode of generating the guide word through the natural language generation algorithm includes but is not limited to template filling, for example, if the compatible keywords are pungency+hamburger, one guide word of “search for pungent hamburger” may be obtained through the implementation mode of generating the guide word through the natural language generation algorithm.

The embodiment shown in FIG. 2 discloses a method of displaying the guide word to the user before the user performs any interaction behavior. The guide word before the user performs any interaction behavior is obtained by integrating the second keyword set obtained on the basis of the historical orders and the preference data of the user, and the third keyword set obtained on the basis of the trending search words (trending search commodities and trending search merchants) and commodity supply conditions of the current located geographic area of the user. Therefore, a click rate and a conversion rate of the guide word and user experience may be effectively improved.

FIG. 3 shows a schematic flow diagram of a guide word recommendation method according to still another exemplary embodiment of the present application. The present embodiment is on the basis of the above embodiments, and performs exemplary description by taking how to obtain a guide word to be recommended in each interaction process as an example. As shown in FIG. 3, the guide word recommendation method includes the following steps 301-304.

Step 301: Merging and de-duplication operation is performed on a first keyword set, a second keyword set and a third keyword set to obtain a target keyword set.

In an embodiment, for performing the merging and de-duplication operation on a plurality of keyword sets, reference may be made to descriptions of Step 202 of the embodiment shown in FIG. 2, and it will not be described in detail herein.

In an embodiment, the second keyword set and the third keyword set are identical in each interaction in the current login process of the user, so that the merging and de-duplication operation on the second keyword set and the third keyword set may be realized through operation in Step 202 to obtain a fourth keyword set. Therefore, in a subsequent t^{th} interaction, merging and de-duplication operation may be performed on the fourth keyword set and the first keyword set to obtain a t^{th} target keyword set. It is not necessary to update all the keyword sets in each interaction, so that a load of a server may be effectively reduced.

Step 302: Compatible keywords in the target keyword set are obtained.

In an embodiment, a second database may be built in advance. Compatible keywords and incompatible keywords are stored in the second database. Therefore, the second database may be inquired on the basis of the keywords in the target keyword set, and an incompatible keyword combination and a compatible keyword combination are determined. For example, if keywords such as “chili”, “coffee” and “hamburger” exist in the target keyword candidate set, the compatible keywords of “chili+hamburger” may be determined.

Step 303: An initial guide word candidate set is generated from the compatible keywords in the target keyword set through a natural language generation algorithm.

In an embodiment, an implementation mode of generating the guide word through the natural language generation algorithm includes but is not limited to template filling, for example, if the compatible keywords are pungency+hamburger, one guide word of “search for pungent hamburger” may be obtained through the implementation mode of generating the guide word through the natural language generation algorithm.

Step 304: Guide words not meeting a supply condition in the initial guide word candidate set are deleted to obtain the guide word candidate set.

In an embodiment, for each sentence of guide word in the initial guide word candidate set, whether an inquiry condition corresponding to the guide word has supply or not is judged one by one, and if no supply exists, the guide word is deleted, thus avoiding reduction of an experience effect of the user caused when the user clicks the guide word but cannot place an order.

The embodiment shown in FIG. 3 may further improve the experience effect of the user by deleting the guide words not meeting the supply conditions in the initial guide word set.

FIG. 4 is a schematic flow diagram of a guide word recommendation method according to yet another exemplary embodiment of the present application. The present embodiment is on the basis of the above embodiments, and performs exemplary description by taking how to obtain interaction features of each interaction of a user, determine a guide word to be recommended on the basis of the interaction features and rank and display the guide words to be recommended as an example. As shown in FIG. 4, the guide word recommendation method includes the following steps 401-406.

Step 401: A first keyword set is determined on the basis of current interaction behavior data of the user.

Step 402: A guide word candidate set is generated on the basis of the first keyword set, a second keyword set and a third keyword set, and features of each guide word in the guide word candidate set are determined.

In an embodiment, the second keyword set is obtained on the basis of historical orders and preference data of the user, and the third keyword set is obtained on the basis of trending search words and commodity supply information of a current located geographic area of the user.

In an embodiment, for an obtaining method of the features of each guide word, reference may be made to descriptions of Step 103 of the embodiment shown in FIG. 1, and it will not be described in detail herein.

In an embodiment, for descriptions of Step 401 and Step 402, reference may be made to descriptions in Step 101 and Step 102 of the embodiment shown in FIG. 1, and those will not be described in detail herein.

Step 403: Current interaction features of the user are obtained on the basis of the current interaction behavior data and previous interaction features of the user.

In an embodiment, the current (t^{th}) interaction features of the user may be obtained through calculation on the t^{th} interaction behavior data and the previous ((t−1)^{th}) interaction features. For example, the t^{th} interaction behavior data and the (t−1)^{th} interaction features may be input into the recurrent neural network, and the recurrent neural network outputs the t^{th} interaction features. The t^{th} interaction behavior data includes but is not limited to interaction behaviors such as click, ordering, active input and merchant and/or commodity detail page browsing. In the 0^{th} time, that is, when t=0, the user does not have an interaction behavior, and S₀ is a hidden variable output of a RNN initial state.

Step 404: An expected value of each guide word in the guide word candidate set s calculated by using an expected value function.

In an embodiment, for descriptions of Step 404, reference may be made to descriptions ilk of Step 104 of the embodiment shown in FIG. 1, and those will not be described in detail herein.

Step 405: At least one guide word with an expected value higher than a preset value threshold is determined as a guide word to be recommended.

Step 406: The guide words to be recommended are ranked and displayed according to a descending sequence of the expected values.

When the interaction features of a t^{th} interaction are calculated, besides considering the interaction behavior data of the t^{th} interaction, the interaction features of a (t−1)^{h} interaction are also considered, so that the guide word recommendation method provided by the present application considers real-time preference displayed in real-time interaction. Therefore, the guide word displayed in each interaction may better conform to the user expectations.

It should be noted that the above embodiments take food as examples for exemplary description, and it would be understood by those skilled in the art that for different types of commodities, such as clothes, shoes and caps, the guide word may be generated in the mode of the present application, that is, the guide word recommendation method in the present application is not limited to the food.

Corresponding to the embodiments of the foregoing guide word recommendation method, the present application further provides an embodiment of a guide word recommendation device.

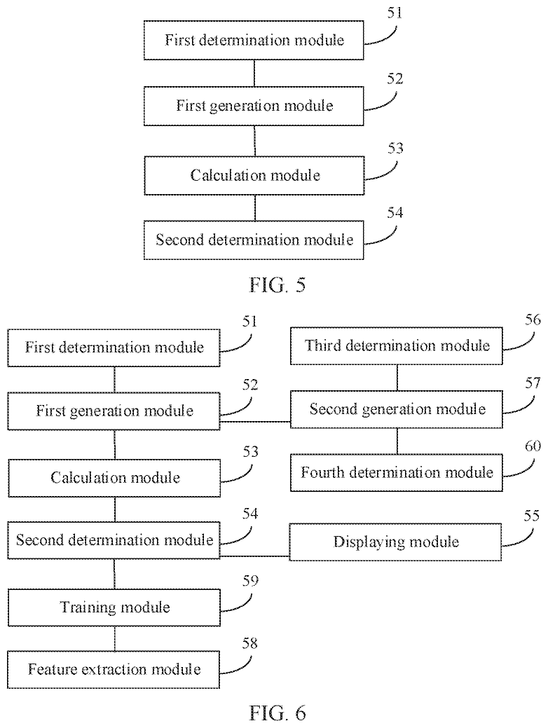

FIG. 5 shows a block diagram of a guide word recommendation device according to an exemplary embodiment of the present application. As shown in FIG. 5, the guide word recommendation device includes:

a first determination module 51, configured to determine a first keyword set on the basis of current interaction behavior data of a user;

a first generation module 52, configured to generate a guide word candidate set on the basis of the first keyword set, a second keyword set and a third keyword set, where the second key word set is obtained on the basis of historical orders of the user and associated preference data, and the third keyword set is obtained on the basis of trending search words and commodity supply information of a current located geographic area of the user;

a calculation module 53, configured to calculate an expected value of a guide word by using an expected value function for each guide word in the guide word candidate set; and

a second determination module 54, configured to determine at least one guide word with the expected value higher than a preset value threshold as a guide word to be recommended.

FIG. 6 shows a block diagram of a guide word recommendation device according to another exemplary embodiment of the present application. As shown in FIG. 6, on the basis of the embodiment shown in FIG. 5, the device further includes:

a displaying module 55, configured to display the guide words to be recommended according to a descending sequence of the expected values.

In an embodiment, the first determination module 51 is configured to: search for merchant data and/or commodity data associated with the current interaction behavior data of the user in a first database, where the current interaction behavior data of the user is obtained on the basis of at least one of following operations triggered by the user: active input, click, or merchant and/or commodity detail page browsing; and determine the first keyword set on the basis of the associated merchant data and/or commodity data.

In an embodiment, the first generation module 52 is configured to: perform merging and de-duplication operation on the first keyword set, the second keyword set and the third keyword set to obtain a target keyword set; obtain compatible keywords in the target keyword set; generate an initial guide word candidate set from the compatible keywords in the target keyword set through a natural language generation algorithm; and delete the guide words not meeting supply conditions in the initial guide word candidate set to obtain the guide word candidate set.

In an embodiment, the device further includes a third determination module 56, configured to determine the second keyword set and the third keyword set when the user is detected to login in; and a second generation module 57, configured to perform merging and de-duplication operation on the second keyword set and the third keyword set to obtain a fourth keyword set. Under the condition, the first generation module 52 is configured to perform merging and de-duplication operation on the fourth keyword set and the first keyword set to obtain the target key word set.

In an embodiment, the calculation module 53 is configured to: obtain current interaction features of the user; determine features of the guide word; and calculate the features of the guide word, and the current interaction features and non-interaction features of the user by using the expected value function to obtain the expected value of the guide word. The non-interaction features are irrelevant to a current interaction behavior of the user but influence ordering of the user.

In an embodiment, the calculation module 53 is configured to: obtain previous interaction features of the user; and obtain the current interaction features of the user on the basis of the current interaction behavior data of the user and the previous interaction features of the user.

In an embodiment, the calculation module 53 is configured to: obtain keywords in the guide word, information of a commodity which the guide word is capable of being linked to and/or information of a merchant which the guide word is capable of being linked to, and a matching degree between the guide word and the preference data of the user for each guide word; and determine the keywords in the guide word, the information of the commodity which the guide word is capable of being linked to and/or the information of the merchant which the guide word is capable of being linked to, and the matching degree as the features of the guide word.

In an embodiment, the device further includes: a feature extraction module 58 configured to extract interaction features corresponding to interaction behavior data of a training sample to obtain training features; and a training module 59 configured to train an expected value model by using the training features to obtain the expected value function.

In an embodiment, the second determination module 54 is configured to: determine a set number of guide words with highest expected values as the guide words to be recommended in a t^{th} interaction; and rank and display the guide words to be recommended according to a descending sequence of the expected values.

In an embodiment, the device further includes: a fourth determination module 60 configured to determine a guide word to be recommended before an interaction behavior occurs on the basis of the second keyword set and the third keyword set when the user is detected to login in.

The apparatus embodiments basically correspond to the method embodiments, and therefore, reference may be made to the method embodiments for the associated part. The foregoing described apparatus embodiments are merely exemplary. The units described as separate parts may be or may be not physically separated. The part displayed as a unit may be or may be not a physical unit, that is, may be located at one place or distributed on multiple network units. Some or all of the modules may be selected according to practical requirements to achieve the objectives of the solution in this application. A person of ordinary skill in the art may understand and carry out the solution without creative efforts.

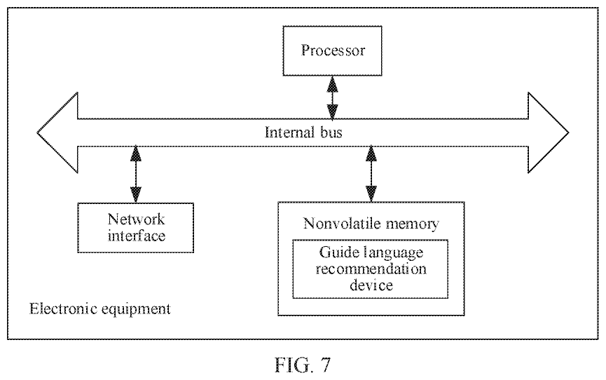

Corresponding to the foregoing guide word recommendation method, a schematic structural diagram of electronic equipment according to an exemplary embodiment of the present application shown in FIG. 7 is further provided in this application. Referring to FIG. 7, at the hardware level, the electronic equipment includes a processor, an internal bus, a network interface, and a non-volatile memory, and certainly may further include hardware required for other services. The processor reads a corresponding computer program from the non-volatile memory into the memory and then executes the computer program, to form a guide word recommendation apparatus at the logic level. Definitely, in addition to a software implementation, this application does not exclude other implementations, for example, a logic device or a combination of software and hardware. In other words, an entity executing the following processing procedure is not limited to the logic units, and may also be hardware or logic devices.

In an exemplary embodiment, a computer-readable storage medium is further provided. The storage medium stores a computer program, the computer program being configured to perform the foregoing guide word recommendation method. The computer-readable storage medium may be a ROM, a RAM, a CD-ROM, a magnetic tape, a floppy disk, or an optical data storage device, or the like.

After considering the specification and implementing the present invention disclosed herein, persons skilled in the art can readily think of other implementations of this application. This application is intended to cover any variation, use, or adaptive change of this application. These variations, uses, or adaptive changes follow the general principles of this application and include common general knowledge or common technical means in the art that are not disclosed in this application. The specification and the embodiments are merely considered as examples, and the actual scope and the spirit of this application are pointed out by the following claims.

It should also be noted that the terms “include”, “comprise” and any other variants mean to cover the non-exclusive inclusion. Thereby, the process, method, article, or device which includes a series of elements not only includes those elements, but also includes other elements which are not clearly listed, or further includes the inherent elements of the process, method, article or device. An element preceded by “includes a . . . ” does not, without more constraints, preclude the existence of additional identical elements in the process, method, article, or device that includes the element.

The above descriptions are merely exemplary embodiments of this application, but not intended to limit this application. Any modification, equivalent replacement, improvement, or the like made in accordance with the spirit and principle of this application should fall within the protection scope of this application.

1. A computer-implemented guide word recommendation method, comprising:
determining, by an electronic equipment, a first keyword set on the basis of current interaction behavior data of a user;
generating, by the electronic equipment, a guide word candidate set on the basis of the first keyword set, a second keyword set and a third keyword set, wherein the second keyword set is obtained based on historical orders and preference data of the user, and the third keyword set is obtained based on trending search words and commodity supply information of a current located geographic area of the user;
for each guide word in the guide word candidate set, calculating, by the electronic equipment, an expected value of the guide word by using an expected value function; and
determining, by the electronic equipment, at least one guide word with the expected value higher than a preset value threshold as a guide word to be recommended.

2. The method according to claim 1, further comprising:
displaying, by the electronic equipment, guide words to be recommended according to a descending sequence of the expected values.

3. The method according to claim 1, wherein determining the first keyword set comprises:
searching, by the electronic equipment, for merchant data and/or commodity data associated with the current interaction behavior data of the user in a first database, wherein the current interaction behavior data of the user is obtained based on at least one of following operations triggered by the user: active input, click, or merchant and/or commodity detail page browsing; and
determining, by the electronic equipment, the first keyword set on the basis of the associated merchant data and/or commodity data.

4. The method according to claim 1, wherein generating the guide word candidate set on the basis of the first keyword set, the second keyword set and the third keyword set comprises:
performing, by the electronic equipment, merging and de-duplication operation on the first keyword set, the second keyword set and the third keyword set to obtain a target keyword set;
obtaining, by the electronic equipment, compatible keywords in the target keyword set;
generating, by the electronic equipment, an initial guide word candidate set from the compatible keywords in the target keyword set through a natural language generation algorithm; and
deleting, by the electronic equipment, guide words not meeting a supply condition in the initial guide word candidate set to obtain the guide word candidate set.

5. The method according to claim 4, further comprising:
determining, by the electronic equipment, the second keyword set and the third keyword set when the user is detected to log in; and
performing, by the electronic equipment, merging and de-duplication operation on the second keyword set and the third keyword set to obtain a fourth keyword set.

6. The method according to claim 5, wherein performing the merging and de-duplication operation on the first keyword set, the second keyword set and the third keyword set to obtain the target keyword set comprises:
performing, by the electronic equipment, merging and de-duplication operation on the fourth keyword set and the first keyword set to obtain the target keyword set.

7. The method according to claim 1, wherein calculating the expected value of the guide word by using the expected value function comprises:
obtaining, by the electronic equipment, current interaction features of the user;
determining, by the electronic equipment, features of the guide word; and
calculating, by the electronic equipment, the features of the guide word, and the current interaction features and non-interaction features of the user by using the expected value function to obtain the expected value of the guide word, wherein the non-interaction features are irrelevant to a current interaction behavior of the user, but influence ordering of the user.

8. The method according to claim 7, wherein obtaining the current interaction features of the user comprises:
obtaining, by the electronic equipment, previous interaction features of the user; and
obtaining, by the electronic equipment, the current interaction features of the user based on the current interaction behavior data of the user and the previous interaction features of the user.

9. The method according to claim 7, wherein obtaining the features of the guide word comprises:
obtaining, by the electronic equipment, keywords of the guide word, information of a commodity to which the guide word is linkable, information of a merchant to which the guide word is linkable, and a matching degree between the guide word and the preference data of the user; and
determining, by the electronic equipment, the keywords of the guide word, the information of the commodity which the guide word is linkable, the information of the merchant which the guide word is capable of being linked to, and the matching degree as the features of the guide word.

10. The method according to claim 1, further comprising:
extracting, by the electronic equipment, user interaction features corresponding to interaction behavior data of a training sample to obtain training features; and
training, by the electronic equipment, an expected value model by using the training features to obtain the expected value function.

11. The method according to claim 1, further comprising:
determining, by the electronic equipment, a guide word to be recommended before an interaction behavior occurs on the basis of the second keyword set and the third keyword set when the user is detected to log in.

12. (canceled)

13. An electronic equipment, comprising a memory, a processor and a computer program stored on the memory and capable of running on the processor, wherein when executing the computer program, the processor is caused to perform:
determining a first keyword set on the basis of current interaction behavior data of a user;
generating a guide word candidate set on the basis of the first keyword set, a second keyword set and a third keyword set, wherein the second keyword set is obtained based on historical orders and preference data of the user, and the third keyword set is obtained based on trending search words and commodity supply information of a current located geographic area of the user;
for each guide word in the guide word candidate set, calculating an expected value of the guide word by using an expected value function; and
determining at least one guide word with the expected value higher than a preset value threshold as a guide word to be recommended.

14. A non-transitory computer readable storage medium,
wherein the storage medium stores a computer program, and when the computer program is executed by a processor, the processor is caused to perform:
determining a first keyword set on the basis of current interaction behavior data of a user;
generating a guide word candidate set on the basis of the first keyword set, a second keyword set and a third keyword set, wherein the second keyword set is obtained based on historical orders and preference data of the user, and the third keyword set is obtained based on trending search words and commodity supply information of a current located geographic area of the user;
for each guide word in the guide word candidate set, calculating an expected value of the guide word by using an expected value function; and
determining at least one guide word with the expected value higher than a preset value threshold as a guide word to be recommended.

15. The electronic equipment according to claim 13, wherein the processor is further caused to perform:
displaying guide words to be recommended according to a descending sequence of the expected values.

16. The electronic equipment according to claim 13, wherein determining the first keyword set comprises:
searching for merchant data and/or commodity data associated with the current interaction behavior data of the user in a first database, wherein the current interaction behavior data of the user is obtained on the basis of at least one of following operations triggered by the user: active input, click, or merchant and/or commodity detail page browsing; and
determining the first keyword set based on the associated merchant data and/or commodity data.

17. The electronic equipment according to claim 13, wherein generating the guide word candidate set on the basis of the first keyword set, the second keyword set and the third keyword set comprises:
performing merging and de-duplication operation on the first keyword set, the second keyword set and the third keyword set to obtain a target keyword set;
obtaining compatible keywords in the target keyword set;
generating an initial guide word candidate set from the compatible keywords in the target keyword set through a natural language generation algorithm; and
deleting guide words not meeting a supply condition in the initial guide word candidate set to obtain the guide word candidate set.

18. The electronic equipment according to claim 17, wherein the processor is further caused to perform:
determining the second keyword set and the third keyword set when the user is detected to log in; and
performing merging and de-duplication operation on the second keyword set and the third keyword set to obtain a fourth keyword set.

19. The electronic equipment according to claim 18, wherein performing the merging and de-duplication operation on the first keyword set, the second keyword set and the third keyword set to obtain the target keyword set comprises:
performing merging and de-duplication operation on the fourth keyword set and the first keyword set to obtain the target keyword set.

20. The electronic equipment according to claim 13, wherein calculating the expected value of the guide word by using the expected value function comprises:
obtaining current interaction features of the user;
determining features of the guide word; and
calculating the features of the guide word, and the current interaction features and non-interaction features of the user by using the expected value function to obtain the expected value of the guide word, wherein the non-interaction features are irrelevant to a current interaction behavior of the user, but influence ordering of the user.

21. The electronic equipment according to claim 13, wherein the processor is further caused to perform:
extracting user interaction features corresponding to interaction behavior data of a training sample to obtain training features; and
training an expected value model by using the training features to obtain the expected value function.
